(19) United States
(12) Patent Application Publication
(10) Pub. No.: US 2013/0342190 A1
(43) Pub. Date: Dec. 26, 2013

(54) Through Shaft Rotary Position Sensor

(71) Applicant: Nicholas William Payne, New Milford, CT (US)

(72) Inventor: Nicholas William Payne, New Milford, CT (US)

(21) Appl. No.: 13/567,725

(22) Filed: Aug. 6, 2012

Related U.S. Application Data
(60) Provisional application No. 61/524,392, filed on Aug. 17, 2011.

(51) Int. Cl. G01B 7/30

(52) U.S. Cl. CPC G01B 7/30
USPC 324/207.2

(57) ABSTRACT

A rotary shaft sensor assembly includes 2 arc section magnets extending around the outer surface of a rotatable through shaft, arranged some distance from the shaft to produce a field, constant in strength and direction over a sufficiently large area. A sensor which measures changes in the direction of the magnetic flux generated by the magnets in response to rotation of the shaft is located anywhere in the field of constant strength and direction, specifically not needing to be located at the axis of rotation of the shaft. Optionally another such sensor can be mounted anywhere in the field at right angles to the first to allow for sensing over the full range of rotation of the shaft.

### CROSS REFERENCE TO RELATED APPLICATION

This application claims the benefit of the filing date and disclosure of U.S. Provisional Application Ser. No. 61/524,392 filed 17 Aug. 2011 which is explicitly incorporated herein by reference as are all references cited herein.

### FIELD OF THE INVENTION

This invention relates to a rotary position sensor assembly and more specifically to a non-contacting rotary position sensor assembly using a Hall effect sensor.

### STATEMENT REGARDING FEDERALLY SPONSORED RESEARCH AND DEVELOPMENT

[not applicable]

### REFERENCE TO SEQUENCE LISTING, A TABLE OR A COMPUTER PROGRAM LISTING COMPACT DISK APPENDIX

[not applicable]

### BACKGROUND OF THE INVENTION

Non contacting rotary position sensor assemblies which are available today for detecting and measuring the rotary position of an object include a magnet and a Hall effect sensor adapted to sense the direction of the magnetic field in two dimensions.

The use of this type of Hall sensor is becoming increasingly common for detecting the angle or position of the shaft of the rotary position sensor where the magnet can be mounted to one of the distal end surfaces of the shaft which then allows the Hall sensor to be mounted in a relationship and position axial to the centerline of the shaft.

This arrangement, however, is not possible in applications where the part requires the use of a through shaft and the end of the through shaft is not available for mounting a magnet thereto. The means and the methods available today for sensing the angle and position of such a through shaft sensor have proven to include a variety of limitations and, in certain applications, have required the use of custom Hall effect sensors with custom magnetic field measurement capabilities.

### SUMMARY OF THE INVENTION

The present invention is directed to a rotary position sensor assembly which comprises a shaft, a magnet assembly fixed to the shaft and adapted to generate a magnetic flux constant in strength and direction, with respect to the magnet assembly over a sufficiently wide area, and a sensor placed in this field, hereinafter referred to as the “constant field”

In the preferred embodiment, the magnets are two arcs opposite each other on a circular form centered on the shaft. The circular form will preferentially be of a ferromagnetic material to improve the overall field strength. The length of the arcs is designed to create a field of constant strength and direction as required. The advantage of this approach is that the sensor can be placed anywhere in this field in order to detect rotation over a 90 deg angle. The sensor is arranged so that in the middle of the 90 degree detection range the magnetic field is parallel to the detection plane of the sensor and thus detects no field. As the shaft carrying the magnetic field swings +/−45 degrees from this point the detected field is proportional to the sine of the subtended angle, a non linearity easily corrected in firmware.

This allows detection over two 90 degree arcs, assuming an arbitrary zero 0 to 90 degrees and 180 to 270 degrees

Further to this another sensor can be placed with its plane of detection at right angles to the first sensor at any convenient place in the constant field, and perform detection assuming the same arbitrary zero as above in the range of 90 to 180 degrees and 270 to 360 degrees

The advantages of this arrangement is that is it mostly immune to shaft run out and nutation as it rotates and so is tolerant of worn bearings

### BRIEF DESCRIPTION OF THE DRAWINGS

In the accompanying drawings that form part of the specification, and in which like numerals are employed to designate like parts throughout the same

FIG. 1 is representative of prior art, with the sensor fixed in a location on the shaft centerline above the free end of the shaft

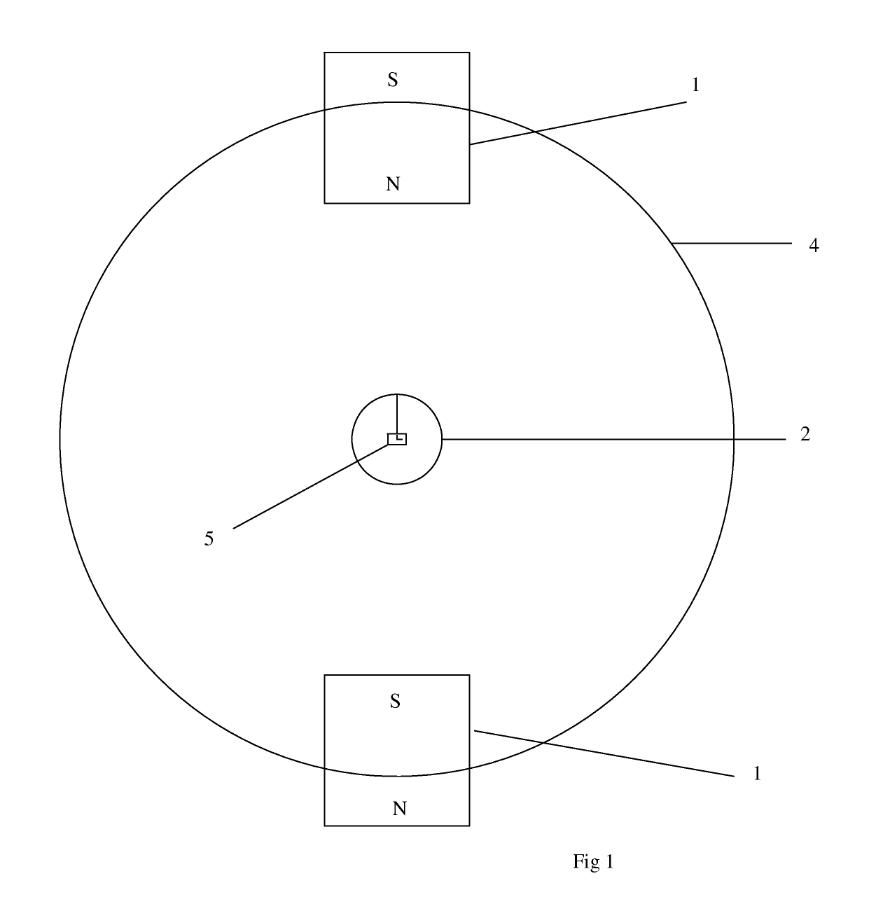

FIG. 2 is a simplified, enlarged, top plan view of a through shaft rotary sensor assembly in accordance with the present invention.

### DETAILED DESCRIPTION OF THE EMBODIMENT

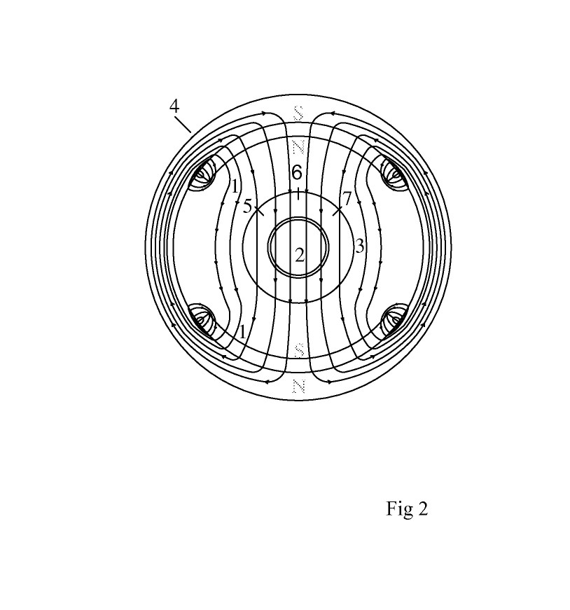

FIG. 2 depicts a simplified embodiment of a through shaft non-contacting rotary position sensor assembly in accordance with the present invention which comprises at least the following key elements: an elongate, preferentially non magnetic, generally cylindrically-shaped through shaft 2 adapted for coupling to a part (not shown) whose rotary or angular position is required to be measured, a magnet assembly 1, composed of 2 curvilinear shaped magnets, coupled to the exterior circumferential surface of the shaft 2 at a convenient radial distance surrounded by a ferromagnetic ring to increase field strength, a Hall sensor integrated circuit located somewhere on the locus 3, preferentially between the limits 5 and 7, located in the area of constant field, spaced from the interior circumferential surface of the magnet assembly 1 and positioned in a relationship generally coplanar with the horizontal cross sectional axis of the magnet assembly and with its detection plane in the plane of the shaft axis 2. For ease of visualization, the locus of the Hall sensor 3 is shown, while the field remains stationary. However in the preferred embodiment, the sensor will remain stationary and the shaft and magnet assembly rotate.

Position 6 corresponds to the null point where the plane of the sensor is parallel to the field so no field is detected. Position 5 is −45 degrees with respect to Position 6 and Position 7 is +45 degrees with respect to Position 6

Specifically in the embodiment shown, it can be seen that the magnetic field 8 is constant in strength (shown by the spacing of the field lines) and direction over the entire area of the locus of the Hall sensor 3 and beyond and so as the sensor rotates with respect to the field, the normal component of the magnetic field will vary as per the sine of the angle subtended between the plane of the Hall sensor and the direction of the magnetic field. It can also be shown that a second sensor can be placed anywhere in this constant field and in the preferred embodiment would be placed with its detection plane at 90 degrees to the first sensor. It can also be shown that lateral movement of the magnet assembly due to shaft run out or nutation would have little effect on the sensor output, since it can be visualized as moving the locus 3 by the same amount, which would not cause any meaningful change in the strength or direction of the magnetic field at that point and so no meaningful change in the sensor output.

Numerous variations and modifications of the embodiment described may be effected without departing from the spirit and scope of the novel features of the invention. It is understood that no limitations with respect to the specific sensor assembly are intended or should be inferred. It is of course intended to cover all such modifications that fall within the scope of the claims.

I claim:

1. A rotary position sensor assembly comprising
a shaft
a magnet assembly fixed to the shaft designed to generate a magnetic field of constant strength and direction over a sufficiently large area,
a sensor located anywhere in the abovementioned field, and adapted to measure a change in direction of the magnetic field generated by the magnet assembly in response to a change in the rotary position of the shaft

2. The rotary position sensor assembly of claim 1 where a second sensor is placed in the in the abovementioned field and adapted to measure a change in direction of the magnetic field generated by the magnet assembly in response to a change in the rotary position of the shaft

3. The rotary position sensor assembly of claim 2 where the second sensor is arranged so that its detection plane is perpendicular to the detection plane of the first sensor and perpendicular to the plane of the cross section of the magnet assembly and parallel to the axis of the shaft
